(19) United States
(12) Patent Application Publication
(10) Pub. No.: US 2013/0087044 A1
(43) Pub. Date: Apr. 11, 2013

(54) SORBENT BASED OIL WATER SEPARATOR WITH INTERNAL DECOMPRESSION CHAMBER AND HUB INLET SYSTEM

(71) Applicants: Michael Scott Holtvluwer, Hudsonville (MI); Ken Kubitz, Batavia, IL (US); John Konieczka, Chicago, IL (US)

(72) Inventors: Michael Scott Holtvluwer, Hudsonville (MI); Ken Kubitz, Batavia, IL (US); John Konieczka, Chicago, IL (US)

(21) Appl. No.: 13/646,651

(22) Filed: Oct. 5, 2012

Related U.S. Application Data
(60) Provisional application No. 61/543,724, filed on Oct. 5, 2011.

(51) Int. Cl. B01D 45/04

(52) U.S. Cl. 95/267; 55/319; 55/315; 55/320; 55/329; 55/331

(57) ABSTRACT

A liquid phase separator assembly permits the separation of a high pressure gas phase from a liquid phase through a controlled expansion of the gas phase with the successful agglomeration and separation of the liquid phase all within a single unit. This complete separation of the gas phase facilitates the removal of the gas by venting. The complete separation of the liquid phase optimizes the solvent recovery/cleaning by processing the liquid phase through an engineered media. The liquid phase separator assembly incorporates an internal chamber for decompression and separation as well as for containing a media for purifying the liquid phase, thus reducing overall cost and complexity.

### CROSS-REFERENCE TO RELATED APPLICATION

This application claims the benefit of priority of U.S. provisional application No. 61/543,724, filed Oct. 5, 2011, the contents of which are herein incorporated by reference.

### BACKGROUND OF THE INVENTION

The present invention relates to oil water separators/liquid phase separators used to collect, separate and purify compressor condensate. Compressor condensate includes a high pressure gas/liquid (oil/water) mixture that is expelled as part of the normal operation of an air compressor. Typical liquid phase separation includes a multi-stage device in which the gas and liquid phase are separated within a separate chamber and the resulting liquid phase is transferred to a separate container for purification. This invention includes a sorbent-based oil water separator with an internal vapor phase separator (separates gas and liquid) and decompression chamber with a hub inlet system.

Present sorbent-based oil water separators use external decompression chambers to vent compressed air. These conventional liquid phase separation systems require two external operations and two or more separate devices to separate the compressed air condensate into its gas and liquid components and subsequently process the liquid phase. This adds considerable complexity and added cost to the system.

In addition, conventional systems allow a portion of the liquid phase (vapor) to be vented with the gas phase, allowing the release of contaminates to the environment.

As can be seen, there is a need for an improved liquid phase separator device that can receive a stream of a gas and/or liquid, separate the liquid from the gas, expel the gas and filter and recover the liquid.

### SUMMARY OF THE INVENTION

In one aspect of the present invention, a liquid phase separator system comprises one or more inlet ports directing an inlet flow into a vapor phase separator; an agglomeration chamber receiving the inlet flow and configured to retain a liquid phase of the inlet flow while allowing a gaseous phase of the inlet flow to pass therethrough into a containment vessel; and one or more vents permitting the gaseous phase to exit the containment vessel.

In another aspect of the present invention, a liquid phase separator system comprises one or more inlet ports directing an inlet flow into a vapor phase separator; an agglomeration chamber receiving the inlet flow and configured to retain a liquid phase of the inlet flow while allowing a gaseous phase of the inlet flow to pass therethrough into a containment vessel; one or more vents permitting the gaseous phase to exit the containment vessel; and the liquid phase to exit the agglomeration chamber and deposited unto the engineered media, which in turn the liquid phase is purified as is percolates through the engineered media and the purified liquid is collected at the bottom of containment vessel and transferred via a collection tube by volume displacement to the outlet.

In a further aspect of the present invention, a method for separating a gas phase from a liquid phase of a fluid flow comprises passing the fluid flow into one or more inlet ports of a vapor phase separator; delivering the fluid flow into an agglomeration chamber; retaining/restricting the liquid phase of the fluid flow in the agglomeration chamber while allowing the gas phase to pass therethrough; and permitting the gaseous phase to exit a containment vessel through one or more vents.

These and other features, aspects and advantages of the present invention will become better understood with reference to the following drawings, description and claims.

### BRIEF DESCRIPTION OF THE DRAWINGS

FIG. 1 is a cross-sectional side view of a liquid phase separator system according to an exemplary embodiment of the present invention;

FIG. 2 is a detailed cross-sectional side view of a vapor phase separator of the liquid phase separator system of FIG. 1;

FIG. 3 is a cross-sectional view taken along line 3-3 of FIG. 2;

FIG. 4 is a detailed cross-sectional view of an injection port of the vapor phase separator of FIG. 2;

FIG. 5 is a cross-sectional side view of a vapor phase separator according to another exemplary embodiment of the present invention;

FIG. 6 is a cross-sectional view taken along line 6-6 of FIG. 5;

FIG. 7 is a cross-sectional side view of a vapor phase separator according to another exemplary embodiment of the present invention; and

FIG. 8 is a cross-sectional view taken along line 8-8 of FIG. 7.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a vapor phase separator assembly that permits the separation of a high pressure gas phase from a liquid phase through a controlled expansion of the gas phase with the successful agglomeration and separation of the liquid phase all within a single unit. This complete separation of the gas phase facilitates the removal of the gas by venting. The complete separation of the liquid phase optimizes the solvent recovery/cleaning by processing the liquid phase through an engineered media. The liquid phase separator assembly incorporates an internal chamber for decompression and separation as well as for containing a media for purifying the liquid phase, thus reducing overall cost and complexity.

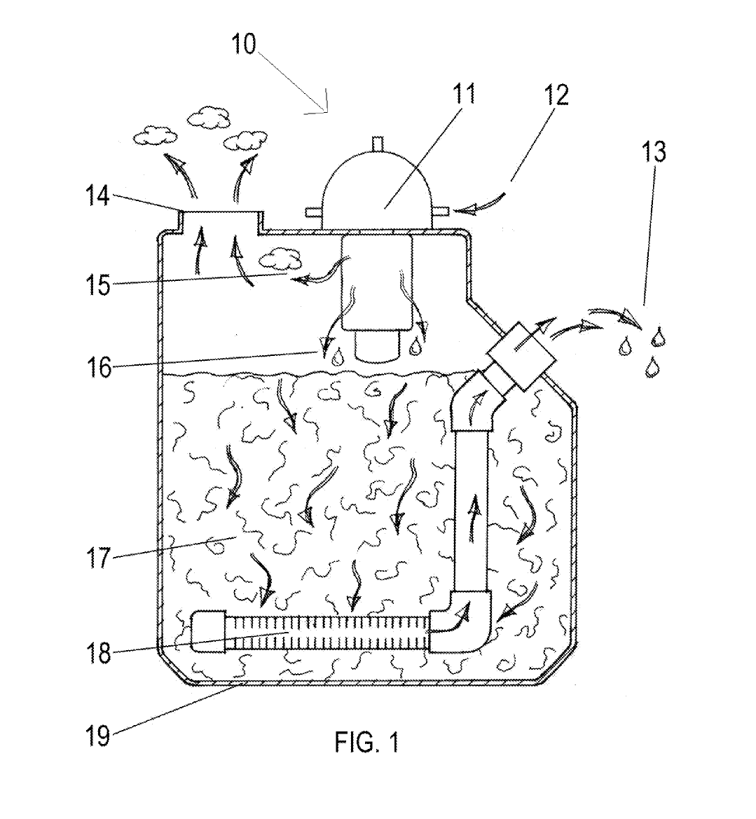

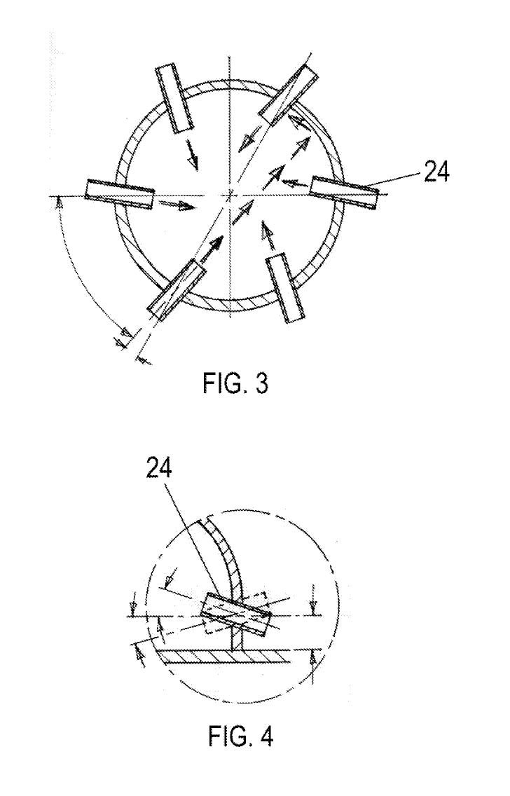

Referring now to FIGS. 1 through 4, a liquid phase separator system 10 is a system that allows both continuous and intermittent discharges of high temperature (up to 200° F.) and high pressure (up to 200 psi) sorbent vapor to a vapor phase separator 11 which, in turn, continuously or intermittently separates a liquid phase from a gas phase in an inlet flow 12. The gas phase 15 is released through vents 14 without imparting pressure to an internal vessel 19. The liquid phase 16 is deposited onto the top of engineered media 17 where it flows/permeates by gravity through the engineered media 17 allowing contaminates to be removed from the liquid phase 16 and adsorbed/concentrated by the engineered media 17. Eventually the cleansed liquid phase 13 migrates to the bottom internal vessel 19 to be collected and transported via a collection tube 18 where it is discharged from the containment vessel 18 by means volume displacement. An anti-siphon device 20 prevents the containment vessel 18 from being prematurely emptied.

The process of the present invention is applicable to many industrial processes, including but not limited to compressor condensate discharge purification, including but not limited to uranium solution separation, including but not limited to waste water treatment and including but not limited to gold solution concentration and refining.

The sorbent vapor that enters the liquid phase separator is generated from an external source. This external source will generate liquid/gas mixture of any combination of gas phase from 0 to 100% as well as the corresponding liquid phase consisting of 0 to 100%. Thus, for example, if the gas percentage is 80% the corresponding liquid percentage would be 20%. The temperature can range from 0° F. to 200° F. The flow can be from continuous to intermittent with years between discharges. The liquid phase particle size can range from 100 angstroms to continuous liquid flow. The liquid/gas mixture entering the liquid phase separator can range from 14.7 psi to 200 psi.

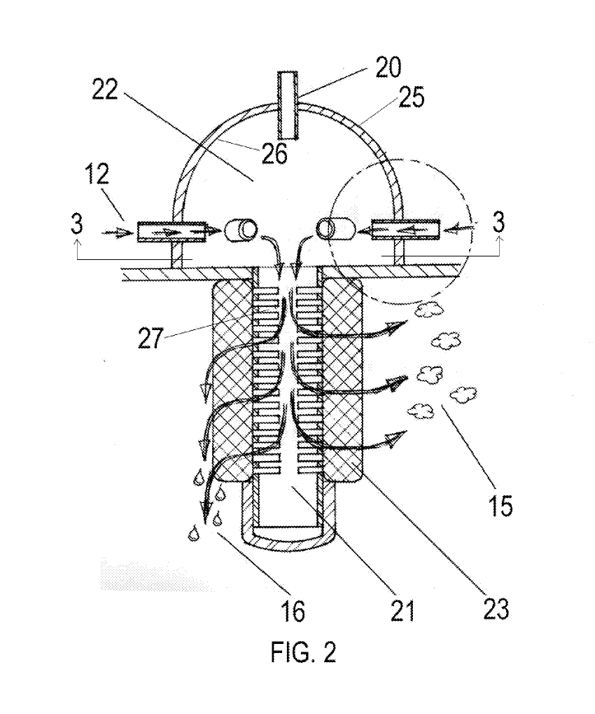

The vapor phase separator 11 includes a radial shell 25 (whose minimum diameter is limited by the size of the inlet couplings) with a collection of inlet ports 24. The radial shell 25 can be spherical as shown in FIGS. 1 and 2 but is not limited to a sphere but can be oval, cylindrical, cubic or some combination of the above. Hence, the external shape of the vapor phase separator 11 does not impede its function.

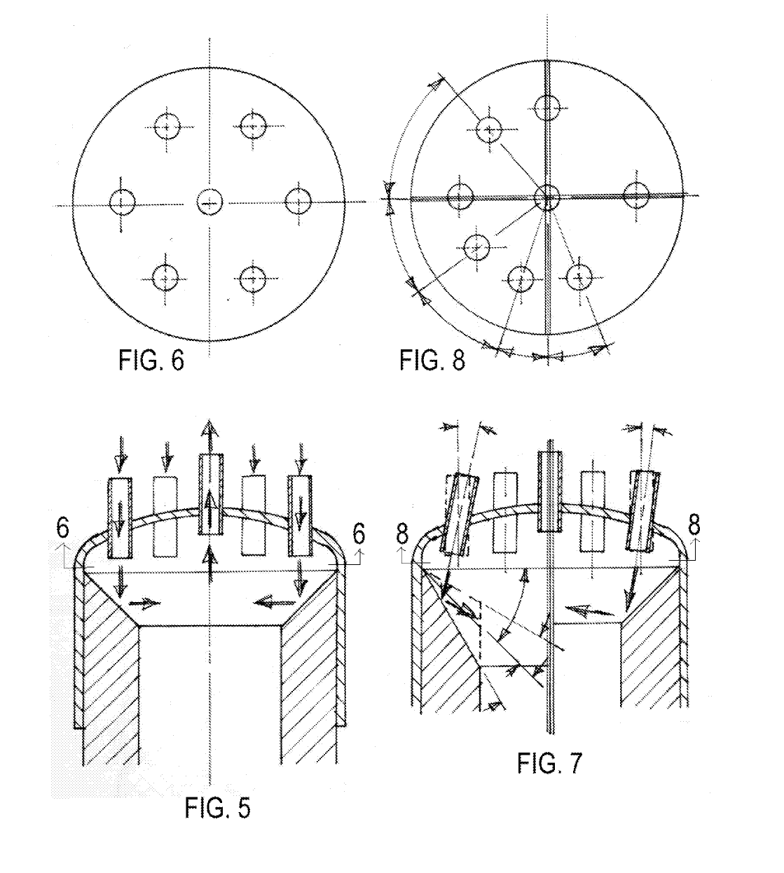

The number of inlet ports 22 is limited by the open surface area contained on the vapor phase separator 11. Hence, the vapor phase separator 11 can include of as many ports that will cover the surface. The example outlined in FIGS. 1 through 4 shows a total of six inlet ports with an extra centralized port used as the anti-siphon port 20. The anti-siphon port 20 is not limited to the central port but any open port could be substituted for the central port. Although six inlet ports are shown, the total number of inlet ports is simply limited by the open surface area, thus many additional ports can be added. Thus, the angle between ports can be from 0 to roughly 90 degrees. Port placement, as shown in in FIGS. 1 through 4 can include a radial placement design. FIGS. 5 through 8 illustrate the port placement in a vertical configuration.

The position of the inlet ports can be horizontal but are not limited to horizontal; furthermore, the position of the inlet ports can be vertical but are not limited to vertical. The placement of the inlet ports can be any combination of horizontal and vertical. Finally, the location of the inlet ports does not impede function such that the inlet ports can be placed in any random location upon the outside of the vapor phase separator external surface provided that the inlet port provides a clear path to the vapor phase separator internal structure. Finally, inlet port size can range from 1/32 in. to over a 1.0 in. The vapor phase separator internal structure is designed to impede/retard the sorbent vapor momentum and redirect the flow toward a liquid phase drain. The high pressure vapor (air and liquid phase) are directed toward a concave structure resulting in turbulent flow. A portion of the gas phase momentum is partially retarded due to the turbulent flow but, in general, the gas phase velocity increases rapidly. Meanwhile the liquid phase is pressed against the vapor phase separator inner wall 26 due to the rapid expansion of the gas phase. The gas phase and liquid phase exit the liquid phase drain 22 and enter the liquid/gas separation tube 21. The liquid phase flows on the outer wall until it encounters a vertical slit 27. The liquid droplet settles on the edge of the slit 27 until the gas, moving at a high velocity, peals the liquid phase droplets from the wall surface creating a fine mist of particles. SMA (Sauter Mean Diameter) particle sizes can range from 10 to 200 μm. This fine mist is then processed through the liquid agglomeration chamber 23. The liquid agglomeration chamber 23 includes, for example, a polyester mesh of fine strands. The fine particles stick to the polyester mesh and combine to create ever larger particles. This process is continued throughout the length of the agglomeration chamber until the resulting liquid phase particles are so large that they flow down the outer surface of the agglomeration chamber 23 and flow onto the engineered media 17 for further processing.

The gas phase flows through the polyester mesh 23 and into the containment vessel 19. The gas 15 collects within the containment chamber 19 until it is forced through the one of the four vents 14. The gas velocity is sufficiently low such that it is incapable of transporting any of the large liquid particles that have accumulated on the agglomeration mesh outer surface.

The liquid particle size that exits the liquid/gas separation tube 21 and the agglomerated tube 23 are governed by the following relationship:

$$\frac{S M {D}_{t}}{t} ∝ {{[ ( {Re}_{t} ) {( {We}_{t} )}^{\frac{1}{2}} ]}^{- 1} [ P ( \frac{x}{{l}_{AVG}} ) ( {l}_{AVG} ) ( {A}_{m} ) ]}^{\frac{L}{{l}_{AVG}}}$$

where
SMD is the “Sauter Mean Diameter” or the average diameter of the particles given a spherical geometry. SMD is governed by the relationship between the Reynolds number and Weber number. “Re” is the Reynolds Number which is a dimensionless number that gives the ratio of internal forces to viscous forces and thus characterizes laminar to turbulent flow. In this case, it is the ratio between the fluid velocities exiting the liquid/gas separation tube slits 27 times the width of the slits divided by the fluid kinematic viscosity. The larger the Reynolds number, the smaller the SMD droplet size. “We” is the Weber Number, which is a dimensionless number that measures a fluid's inertia as compared to its surface tension. This quantity is used to measure the formation of droplets. In this case it is a ratio between the gas phase density, the square of gas phase velocity at the slit exit and the thickness of the liquid phase film at the slit opening divided by the liquid surface tension. Therefore the higher gas velocity, the larger Weber number and the smaller the liquid phase droplet size.

The function of the liquid agglomeration chamber is to combine these small droplets into a size such that they will flow continuously to the engineered media. To achieve this end, the agglomeration media is selected such that the fibers will by wetted by the liquid phase. Therefore the fibers can be constructed from polyester, high density polyethylene or PET or other substrate such that the liquid phase will wet the surface structure.

Given the degree of wetting and the average pour size (mean distance between fibers), the length that a SMD particle will travel before it collides with a fiber can be expressed by the following:

$$[ P ( \frac{x}{{l}_{AVG}} ) ]$$

which is the probability of the SMD size particle will hit and stick to the fiber strand of the liquid agglomeration chamber, where [(l_{AVG})] is the average length of travel till hitting a fiber strand of the liquid agglomeration chamber, [(Aₘ)] is the degree that the particles merge/agglomerate with adjacent particles and L is the thickness of the agglomeration chamber. Thus

$${[ P ( \frac{x}{{l}_{AVG}} ) ( {l}_{AVG} ) ( {A}_{m} ) ]}^{\frac{L}{{l}_{AVG}}}$$

is the degree to which the liquid particles agglomerate to; a size a thousand times greater or more from its original size.

To select the best media for each application, the physical characteristics of the liquid phase are matched to the wetting and pour size of the agglomeration media. The thickness of the agglomeration media is selected such that the resulting liquid phase droplets are of sufficient size that they flow to the engineered media and are too large to be carried away by the gas phase.

The Figures show the gas and liquid phase separation occurring within a single containment vessel. However, these elements, the vapor phase separator and the containment vessel, could be separated into two separate items and connected by a third element. This modification only adds size and cost to the unit.

The development of the internal vapor phase separator allows a sorbent vapor or compressor condensate to be separated into its gas and liquid components within the same containment vessel used for processing of the liquid phase. This complete separation allows all of the liquid phase to be completely processed through the engineered media without a portion of the liquid phase being vented to the atmosphere. The present invention is ideal for maximizing solvent recovery or compressor condensate while minimizing the contamination to the environment.

In addition, the system of the present invention can be used in any vapor separation system that requires the solvent recovery and processing including, compressor condensate, waste water treatment, separating out radioactive elements, oil refining and drilling waste water treatment as well as gold recovery processes.

The system of the present invention provides the following features: (1) a sorbent-based oil water separator with internal decompression chamber and hub inlet system; (2) an internal vapor phase separator capable of separating compressor condensate into both its gas and liquid phase; (3) an internal vapor phase separator which is capable of agglomerating the small 100 angstrom particles to a size sufficiently large such that they flow into the containment vessel instead of venting with the gas phase; (4) to optimize the internal phase separator, a relation was developed between the physical characteristics of the vapor (Weber Number), the flow characteristics of the vapor (Reynolds Number) and the wetting characteristics of the agglomeration media to achieve a particle size of sufficient size such that it flows into the containment vessel instead of venting with the gas phase; (5) the internal phase separator could function as an external unit; (6) an internal phase separator/decompression chamber allows for the separation of the sorbent based oil water vapor into its constituent liquid phase and gas phase within a single vessel. Operating within a single vessel saves space and cost; (7) the internal phase separator can be used to separate a vapor into its liquid and gas components; (8) The internal phase separator can agglomerate the vapor phase into both its liquid phase allowing the gas phase to be separated at both low pressures (slightly greater than surrounding ambient pressure) to in excess of 200 psi as well as from low temperatures (dew point of the liquid phase) to high temperatures (just below the liquid boiling point); and (9) Due to the unique and innovative design of the internal phase separator/decompression chamber (which allows for the vapor phase to agglomerate into large particles), the function of the internal phase separator is independent of the hub inlet geometrical design.

It should be understood, of course, that the foregoing relates to exemplary embodiments of the invention and that modifications may be made without departing from the spirit and scope of the invention as set forth in the following claims.

What is claimed is:

1. A liquid phase separator system comprising:
a containment vessel;
one or more vents permitting the gaseous phase to exit the containment vessel, wherein the containment vessel provides for decompression of the inlet flow; and
a vapor phase separator having:
one or more inlet ports directing an inlet flow into a vapor phase separator; and
an agglomeration chamber receiving the inlet flow and configured to retain a liquid phase of the inlet flow while allowing a gaseous phase of the inlet flow to pass therethrough into a containment vessel.

2. The liquid phase separator system of claim 1, further comprising an engineered media disposed inside the containment vessel, the engineered media receiving the liquid phase as it exits the agglomeration chamber.

3. The liquid phase separator system of claim 1, wherein the agglomeration chamber includes a polymeric mesh.

4. The liquid phase separator system of claim 1, wherein the agglomeration chamber agglomerates particles as small as 100 Angstroms to a size sufficiently large such that they flow into the containment vessel instead of venting with the gaseous phase through the one or more vents.

5. The liquid phase separator system of claim 2, further comprising a collection tube to transport a purified liquid phase after passing through the engineered media and expelling the purified liquid though an exit port.

6. The liquid phase separator system of claim 1, wherein the vapor phase separator includes a liquid/gas separation tube having slits fluidly communicating with the agglomeration chamber.

7. The liquid phase separator system of claim 1, wherein a plurality of inlet ports are disposed in a dome member covering the vapor phase separator.

8. The liquid phase separator system of claim 7, wherein the plurality of inlet ports are configured to the inlet flow directed at an inside surface of the dome member.

9. The liquid phase separator system of claim 1, wherein the containment vessel and the inlet ports are formed in a single device.

10. The liquid phase separator system of claim 9, wherein the agglomeration chamber is formed in the single device.

11. The liquid phase separator system of claim 9, wherein the agglomeration chamber is formed in a device separate from the single device housing the inlet ports and the containment vessel.

12. The liquid phase separator system wherein the vapor phase separator is disposed as an external unit.

13. The liquid phase separator system of claim 1, wherein the vapor phase separator can agglomerate the vapor phase and allow the gas phase to be separated at both pressures slightly greater than surrounding ambient pressure to pressures in excess of 200 psi, as well as temperatures ranging from a dew point of the liquid phase just below boiling point of the liquid phase.

14. The liquid phase separator system of claim 1, wherein the vapor phase separator operates independent of the geometrical design of the one or more inlet ports.

15. A liquid phase separator system comprising:
one or more inlet ports directing an inlet flow into a vapor phase separator;
an agglomeration chamber receiving the inlet flow and configured to retain a liquid phase of the inlet flow while allowing a gaseous phase of the inlet flow to pass therethrough into a containment vessel;
one or more vents permitting the gaseous phase to exit the containment vessel;
an engineered media disposed inside the containment vessel, the engineered media receiving the liquid phase as it exits the agglomeration chamber; and
a transfer tube to collect the liquid phase after passing through the engineered media, wherein
the vapor phase separator includes a liquid/gas separation tube having slits fluidly communicating with the agglomeration chamber.

16. The liquid phase separator system of claim 15, wherein the agglomeration chamber includes a polymeric mesh.

17. The liquid phase separator system of claim 15, wherein a plurality of inlet ports are disposed in a dome member covering the vapor phase separator.

18. The liquid phase separator system of claim 17, wherein the plurality of inlet ports are configured to the inlet flow directed at an inside surface of the dome member.

19. A method for separating a gas phase from a liquid phase of a vapor flow, the method comprising:
passing the fluid flow into one or more inlet ports of a vapor phase separator;
delivering the vapor flow into an agglomeration chamber;
retaining the liquid phase of the vapor flow in the agglomeration chamber while allowing the gas phase to pass therethrough; and
permitting the gaseous phase to exit a containment vessel through one or more vents.
